(19) United States
(12) Patent Application Publication
(10) Pub. No.: US 2008/0046818 A1
(43) Pub. Date: Feb. 21, 2008

(54) NON-ELECTRONIC BOOKS WITH DISPLAYS

(76) Inventors: MARK S. ORGILL, Laguna Beach, CA (US); David G. Kayo, Corona, CA (US)

Correspondence Address: BARCELO & HARRISON, LLP, 22091 WOOD ISLAND LANE, HUNTINGTON BEACH, CA, 92646, US

(21) Appl. No.: 11/743,647

(22) Filed: May 2, 2007

Related U.S. Application Data
(60) Provisional application No. 60/797,493, filed on May 3, 2006.

(51) Int. Cl. G06F 3/00

(52) U.S. Cl. 715/700

(57) ABSTRACT

Methods and apparatus are presented that combine conventional print-based books with electronic displays such as flat-screen monitors. In accordance with aspects of the present invention, conventional books that contain at least one electronic display for showing images such as text, photos, and/or video through a cover of the book may be provided. In one embodiment, images may be assembled from digitized image data stored in a memory device associated with the book. Books according to aspects of the present invention may further include one or more control or command keys or buttons configured for actuation by a reader. Books according to aspects of the present invention may further include inductively coupled charging means for providing power to electronic components of the books. Other methods and apparatus are presented.

This application claims priority to U.S. Provisional Application No. 60/797,493, filed May 3, 2006, which is incorporated herein by reference.

### BACKGROUND OF THE INVENTION

1. Technical Field of the Invention

Implementations consistent with the principles of the invention generally relate to conventional books capable of displaying electronically-generated images through their covers to a reader. More specifically, such conventional books, e.g., bound or loose-leaf books, photo albums, scrap books, and the like, may include a removable or permanently mounted electronic image display module, where desired electronically generated image content may be visible through a cover of the book.

2. Background of Related Art

Conventional books, manuals, manuscripts, religious writings, albums, and other written works and creations are well known. With the advent of “electronic books” or “E-books” (i.e., books published in electronic or digital form), readers can enjoy content of their choice displayed on the screen of a laptop, desktop computer, or similar display device.

E-books exhibit a number of advantages over conventional non-electronic books, and these benefit both the author and reader. For example, electronically generated books can be quickly edited, updated, and distributed without the inherent costs and production lead times realized with conventionally printed materials. An E-book may also offer the reader, at least in some implementations, the ability to perform searches (e.g., text searched) to rapidly locate particular subject matter. Despite this and other advantages of current E-books, the need exists for improved and alternative systems that integrate electronic and printed content. It is desirable to address the limitations in the art.

### BRIEF SUMMARY OF THE INVENTION

Methods and apparatus are presented that combine conventional print-based books with electronic displays such as flat-screen monitors. In accordance with aspects of the present invention, conventional books that contain at least one electronic display for showing images such as text, photos, and/or video through a cover of the book may be provided. In one embodiment, images may be assembled from digitized image data stored in a memory device associated with the book. Books according to aspects of the present invention may further include one or more control or command keys or buttons configured for actuation by a reader. Books according to aspects of the present invention may further include inductively coupled charging means for providing power to electronic components of the books.

Other aspects and advantages of the present invention can be seen upon review of the figures, the detailed description, and the claims that follow.

### BRIEF DESCRIPTION OF THE DRAWINGS

The accompanying drawings are for the purpose of illustrating and expounding the features involved in the present invention for a more complete understanding, and not meant to be considered as a limitation, wherein:

FIG. 1 illustrates an exemplary circuit block diagram according to aspects of the present invention.

FIG. 2 illustrates an exemplary display and user interface embedded into the front cover of a conventional book (e.g., a wedding album) according to aspects of the present invention.

FIG. 3 illustrates an exemplary display and user interface affixed onto the cover of a conventional book (e.g., a text book) by means of a spring loaded clip or similar device according to aspects of the present invention.

FIG. 4 illustrates an exemplary display and user interface (in a clip-on form factor), and a portion of its corresponding charging device, according to aspects of the present invention.

FIG. 5 illustrates an exemplary display and user interface (in an embedded form factor) being positioned to accept inductively coupled charge current from its corresponding, under-table displaced charging coil.

FIG. 6 illustrates an exemplary display and user interface (in an embedded form factor) resting upon a table positioned over the under-table displaced charging coil.

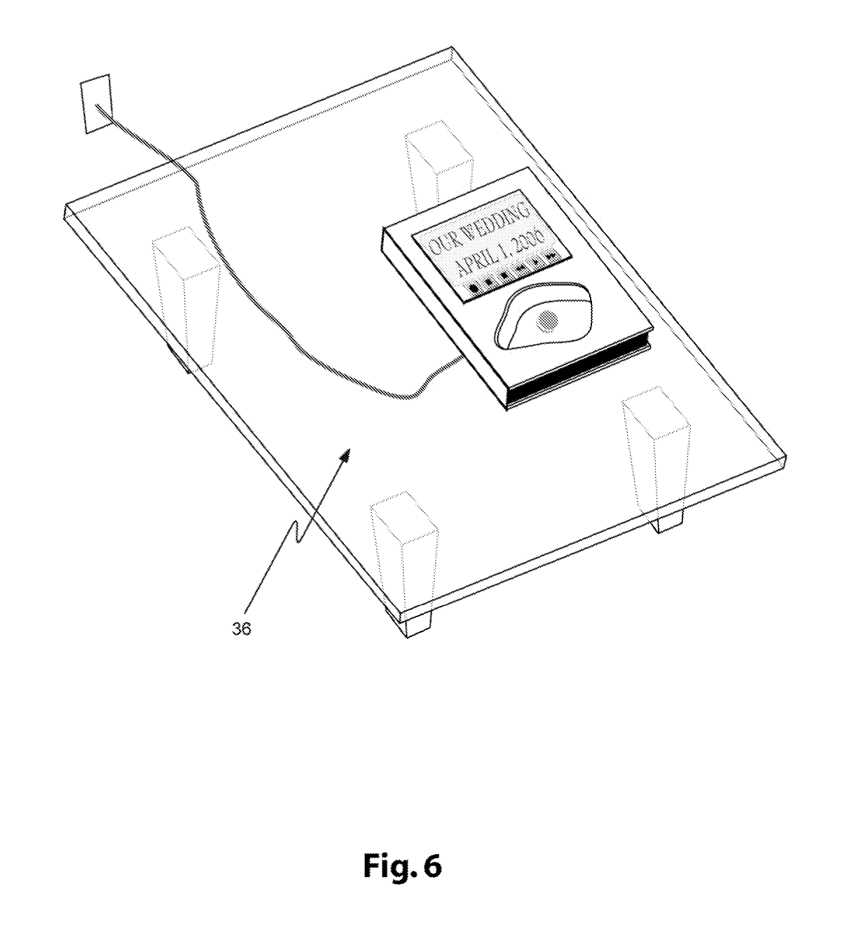

### DETAILED DESCRIPTION

Those of ordinary skill in the art will realize that the following description of the present invention is illustrative only and not in any way limiting. Other embodiments of the invention will readily suggest themselves to such skilled persons, having the benefit of this disclosure. It is also to be understood that the terminology used herein is for the purpose of describing particular embodiments only, and is not intended to limit the scope of the invention defined by the appended claims.

Reference will now be made in detail to an implementation of the present invention as illustrated in the accompanying drawings. The same reference numbers will be used throughout the drawings and the following description to refer to the same or like parts.

According to aspects of the present invention, an integrated book may be provided that allows one or more electronically-stored images to be displayed in the context of a book that also contains one or more conventional printed pages. In one embodiment, images may be displayed on an electronically-generated display visible through a cover of the book. Here, a “book” refers to any article for displaying one or more works of authorship on one or more pages grouped together. Books include, without limitation, those having a conventional binding to bind pages between front and rear covers, as well as notebooks designed to contain loose-leaf material.

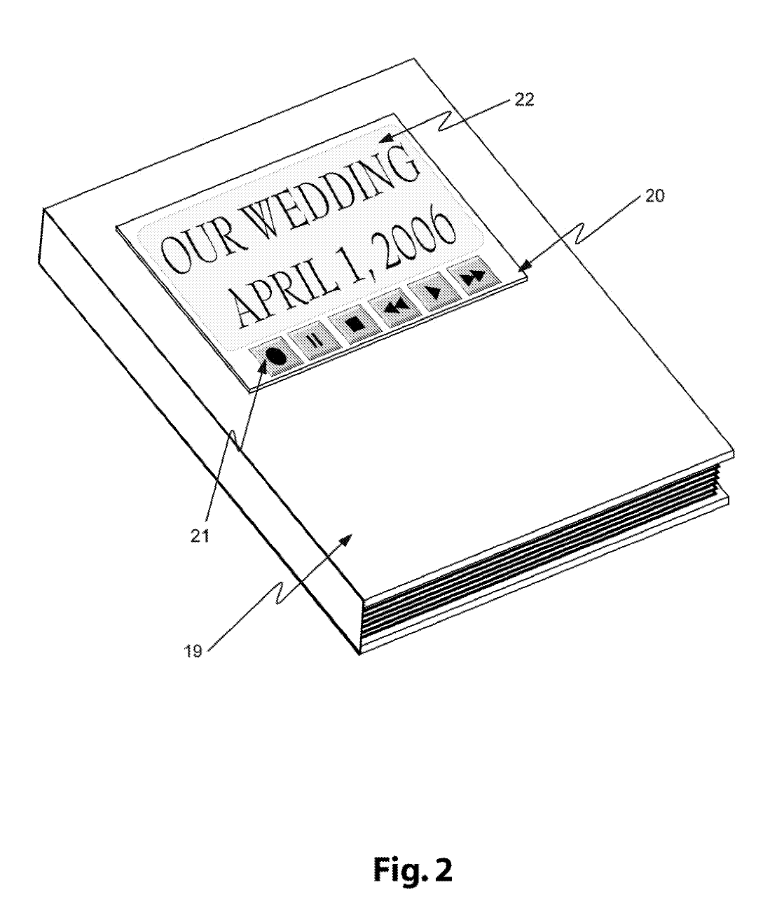

Thus, in one embodiment, the invention concerns conventional page-containing books that also include an electronic display, such as a flat-screen monitor. The display is under the control of an electronic controller, e.g., a microprocessor, configured to control the output of digitized image content stored in a storage device (e.g., an electronic storage device such as a hard drive, CD-ROM, DVD, floppy disk, flash memory device, or other memory device suitable for the storage and retrieval of electronic image data stored therein) operably associated with the book, either by integration with the other circuitry included in the book, or, alternatively, transmitted to the book from a remote transmitter for image data, and optionally, other data such as audio data. Stored or transmitted data can be stored or transmitted in analog or, preferably, digital form. Analog data may be digitized by appropriate circuitry carried onboard the book. A desired image, library of images, video, and the like can be output onto a display screen, at least a portion of which is visible through a window in the book's cover. Given the electronic components in a book according to aspects of the invention, such books also include a power supply suited to power the electronic components provided therein. Suitable power supplies may include those containing one or more batteries. Depending on the needs of each particular implementation, such batteries may be embedded into a display and user interface screen module (such as item 22 shown in FIG. 2) or into a portion of the book, such as its front or rear cover. In such implementations, such batteries may be removable by means of battery compartments that may be opened and closed as needed to access the battery or batteries within.

In certain embodiments, the display may be mounted (permanently or detachably, depending on the particular embodiment) to the rear cover of the book. Indeed, the display may be included within a housing for storage of the various electronic components of the book. In certain embodiments, the storage device used to store electronic image data for display on the display screen is also included in the book (e.g., as part of the display and user interface screen module 22 shown in FIG. 2, or connected to a slot or other receiving terminal incorporated into another portion of the book, such as a front or rear cover). However, in some embodiments, some or all of the electronic image data that can be displayed a particular book's display screen may be stored in a remote storage device, i.e., one not integrated into the book. In such embodiments, electronic image data from the remote storage device may be communicated to the data-processing portion of the book through any suitable approach, including a physical connection between the book and a remote storage device (for example, as through data cables, such as cable configured to transport data in accordance with industry standards such as USB or FireWire™) or wirelessly, for example, through radio frequency, infrared, laser or other wireless form of electronic data transmission adapted for this purpose. As mentioned earlier, depending on the requirements of each particular implementation, a receiving slot or other terminal for the storage device (e.g., a slot for receiving a flash memory device) may be incorporated into a portion of the book such as its front or rear cover, and the data from the storage device may be transmitted to the integrated book's display and user interface screen module (such as module 22 shown in FIG. 2).

As those in the art will appreciate, integrated books according to aspects of the present invention may further include such other circuitry as required to provide a complete, operative integrated book. Such other circuitry may include, for example, one or more communications bases, various memory devices (e.g., read-only and/or random access memories, etc.), transformers, co-processors, video cards, telecommunications devices (e.g., wireless receivers), etc. In some embodiments, the books may further comprise amplifiers and speakers for outputting sound, as may be desired in the output of certain digitized audio/visual material.

It has been recognized that it would be advantageous to develop and provide enhanced printed loose-leaf or bound books. In particular, aspects of the present invention provide an add-on or built-in non-obtrusive multimedia display for presenting digitized image data accessible to a controller disposed in the device, and, in certain embodiments, a user interface module to permit user interaction with the contents of the book via application-specific software created for each book type and title, which may be loaded, for example, from a user attachable memory card or from a wireless source or server. Inclusion of one or more keys or buttons for user actuation of different electronic functionalities in certain embodiments permits a user to activate system features such as “still image” or “moving image”, adjust screen brightness, activate sound and/or adjust volume, enable word or text-specific searches in electronic alphanumeric text, multimedia play back, or link to other devices (such as a personal computer, television, personal digital assistant, and the like).

Integrated books according to aspects of the invention may include one or more displays configured and mounted within or onto a conventional book. If user-actuated keys or buttons are included for controlling various device functions, the keys may be positioned to be in proximity thereto so that the display can function as a user interface and visual media playback as instructed by the user locally via keys or buttons or remotely controlled via a wireless remote control or by automated link, script, or real-time software control from a resident memory device, user-inserted external memory device, remote memory device, server, and the like. Keys or buttons may be assigned function legends by the resident user interface or operating system software, which functions may be wholly or partially overridden in a particular book type or title in order to provide book type and title unique functionality.

If desired, the display of an integrated book according to aspects of the invention may be covered with a reflective coating, for example, to conceal the presence of the electronic display when the display is not illuminated. Such coatings may include those made from reflective coated polymeric films.

As with image data, auditory content may be conveyed as electronic auditory data that, upon processing, controls audio output via one or more speakers or headphone jacks. As will be appreciated, each book type, including unique, one-of-a-kind books (e.g., family photo albums, wedding albums, and the like), may include control program logic for controlling the various electronic functions of the particular book. Such control program logic may be implemented as software, firmware (e.g., as part of an application-specific integrated circuit, or “ASIC”), or as a combination of firmware and software. When used to process data for images and other content (e.g., audio and/or alphanumeric content), a particular book may become unique, in that some or all of the content displayed to a reader may be unique, in that it does not appear in any other book. Of course, two or more books configured to display the same content can also be prepared, although if such a book is configured to provide for reader interactivity in terms of controlling some or all aspects of data output, the images and text presented by the book to a particular reader may differ from reader to reader.

In two alternative embodiments, an integrated book includes a multimedia display and user interface module in one of two configurations. The first includes the display and user interface module built into a compact, thin assembly that is embedded into a book's cover, such that the display screen of the display faces inwardly or outwardly. Depending on the requirements of each particular embodiment, such embedded display and user interface modules may be permanently attached to a portion of the conventional book, or they may be implemented as easily removable and insertable cartridges that may either contain all of the circuitry and functionality required to render them operable or else interface with circuitry in other portions of the conventional book or elsewhere for charging and/or data transmission. Alternatively, the assembly may be mounted into an internal page or other insert of the book. Indeed, particular embodiments could include a plurality of display devices, depending on the display sizes, amount of cover internal space, and book type. Representative examples of books containing an inwardly facing user interface and display may include bound or loose-leaf books for displaying architectural projects. In such embodiments, as the reader opens and/or closes the book, the user interface and display module may manually or automatically begin an audio/video presentation, which may comprise still or moving graphics, pictures, and/or video content, with or without corresponding audio tracks, as well as general audio. In some embodiments, the display may present different images, alone or overlaid with text, silently or in conjunction with sound, relating to each page contained in the book. In this way, the ability to correlate the electronically generated content (i.e., images and/or sound) of the integrated book with the conventionally generated content (e.g., the images and/or text on the conventional pages of the book) enables previously unachievable synergy in terms of the reader's overall experience.

Another representative example of such an integrated book according to aspects of the present invention may include a customized wedding album. In such a book, an outwardly facing display and, if desired, user interface module, may be included. Conventional, non-electronic wedding albums are often displayed as “coffee table” books. In such a context, a wedding album made using a book according to aspects of the invention could provide a reader with a multimedia experience that can display customized and personalized text, graphics, still photos, and/or full motion video, with or without sound.

In other embodiments, the display and user interface module may be detachable, so that it can be attached, for example, to the front cover of an existing, conventionally printed book (e.g., a text book, service manual, user's guide, and the like), or embedded into a portion of the book. Such embodiments may include searching capabilities (e.g., word and/or phrase searching capabilities). In some embodiments, the search functionality may permit a reader to locate words, phrases, and/or graphics by page number and relative page geographical location insomuch as defined as being near “TOP”, “MIDDLE”, and “BOTTOM” of the page. Similarly, the search functions may permit a reader to locate graphics, photos, and/or video content by assigned name, clip location represented by its location in time, or by time markers identifying content, for example.

Image and other data stored for use in such embodiments, like others according to the invention, may be replaced and/or supplemented with updated material delivered, for example, via an online service that provides such data, and/or on a portable memory device (e.g., a CD-ROM, DVD, floppy disk, flash memory device, etc.). As will be appreciated, easily updatable integrated books of this sort could replace conventional textbooks and the like, which typically require periodic updating to remain current and relevant. Indeed, where the pages of the book are adapted for electronic presentation of text and images, regular updates of data for presentation through the one or more displays, alone or in conjunction with updates for text and/or images presented on the page(s) of the book, may allow for updateable books and texts, affording the opportunity for savings by reducing or eliminating the need to purchase updated books. Indeed, such books may allow for more frequent content updating, while at the same time saving physical resources associated with conventional book production and distribution.

As an example, an integrated book according to aspects of the invention could be used as an “all-in-one” text, whereby the information content that would conventionally be stored in each of several topic-specific textbooks could be combined into a single integrated book. The student may select which topic area to present at a particular time by a selection made through a user interface. Depending on the reader's selection, the book may be configured to appear, for example, as the student's science text. Another selection may allow the student to toggle the book to “history” mode, for example, converting the book to a history text. In this way, students may be freed from the need for multiple texts. Indeed, if the book, according to aspects of the present invention, includes features such as image capturing, text highlighting, note and text-editing and word-processing functions, alone or in conjunction with a personal computer, the student may essentially have the opportunity to learn in a “paper-free” environment. Moreover, as updates to information may be regularly provided, students and others using such books may be presented with more current information than is currently commercially practicable. Indeed, with online updating, it may possible to update some or all of the content of a book each time the book is connected to a communications network such as the Internet. Furthermore, with the advent of “wireless” hot spots and other wireless Internet or other network connections, even daily updating may be implemented, depending on the needs of each particular implementation.

For detachable and/or replaceable embodiments, the display and user interface module may be automatically or manually associated with a particular book. Automatic book identification may be conveyed to the display and user interface module, for example, using a barcode, a passive or active tag, and/or any other non-contact asset tracking device or method. Manual entry of the book's identifier may be achieved by entering or otherwise detecting the book's Library of Congress catalog or ISBN number, for example.

As will be appreciated, book type and title-specific software may include data for tables and routines, as well as supportive graphics, pictures, and/or video content, with or without corresponding audio tracks, as well as general audio. These auditory and visual enhancements may be customized, edited, and/or removed and replaced with user-provided content in setup and editing modes of operation. For example, if the particular book is a child's edition, one of the features may be a read-along track intended to help the child improve language skills or reading comprehension. The child's parent may also wish to enable or disable this feature, depending on the child's progress. Further, the parent may wish to personalize the software to include digital images of the child, the child's family, scenes of nature, artwork, etc. that may be placed into an existing graphic along with a particular character from the host conventional book.

The image portions of a particular title for use with an integrated book according to aspects of the invention may contain tutorials, movies, songs, background information, behind-the-scenes footage, outtakes, errata, biographical and bibliographical data, as well as other relevant content that may or may not be useful to the reader at any particular time. For example, if the book is a photo album, wedding album, or scrapbook, the specific media content may comprise memorable video footage or digital photographic images to supplement the fixed non-electronic content in the book. In the case of a wedding album, for example, the user may wish to add footage from her wedding or outtakes from the rehearsal dinner to supplement the conventional still photos that reside within the pages of the non-electronic portion of the integrated book.

In certain embodiments, the book may further include circuitry for wireless communication, such as wireless infrared communication, Bluetooth™, ZigBee™ (a specification set of high level communication protocols for use with small, low power digital radios based on IEEE standard 802.15.4 for wireless personal area networks), and Wi-Fi (i.e., any type of wireless 802.11 network, e.g., 802.11b/g) so as to provide a wireless interface permitting data exchange and/or operation within a wireless network. As a result, software and data for operating a book's type- and title-specific software can be automatically downloaded and updated whenever in the presence of a wireless network. Similarly, image and/or text data may likewise be updated. For example, upon the successful entry of the book's identification number, the controller may initiate a broadcast to identify an accessible wireless network. If a wireless network responds and allows the connection, the controller may run routines to gain online access. Once an online connection is established, the controller may initiate routines to search for and locate appropriate software and updates associated with the book's software.

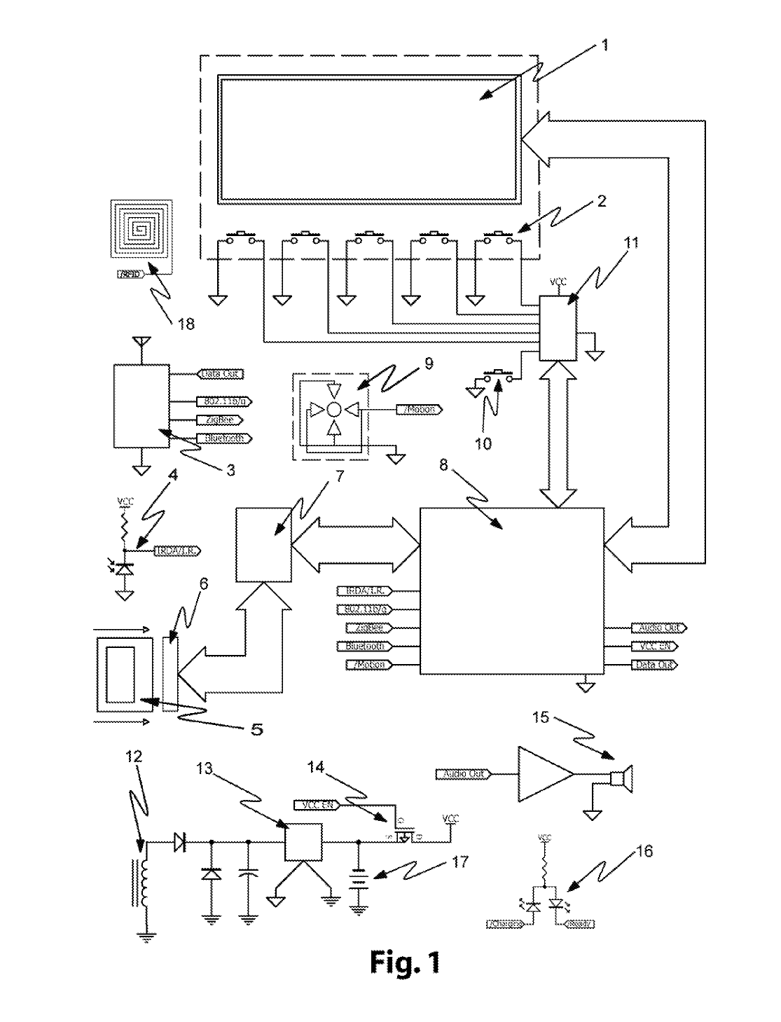

Referring now to FIG. 1, which depicts a display and user interface module circuit block diagram according to one embodiment of the invention, the electronic display (1) in one embodiment is an LCD (liquid crystal display) or television monitor-type display capable of displaying full-motion video as well as graphics and text. Sound may be provided by one or more speakers (15) located in or about the enclosure (not shown) housing the display. Direct entry user accessible function control consists of an array of membrane-type push buttons (2) that may be assigned permanently labeled or software assigned and displayed legends. These pushbutton switches, along with a reset switch (10), are scanned by a multiplexer (11). The reset switch (10) is a concealed but reader-accessible function that allows the reader to perform a factory reset operation to default operation mode in case of a catastrophic error in set up or operation that results in a non-recoverable state or crash. An on-board commercially available microprocessor (8) controls operation, processing management, and distribution of information.

Still referring to the embodiment depicted in FIG. 1, the display and user interface module is a wireless device and is capable of transmitting and receiving data over both optical (4) and radio frequency (3) media. The optical communication method may be effected by any type of formatted infrared radiation type signal. The radio frequency portion (3) of the device is capable of providing wireless communications over any suitable consumer electronic platform, such as those used in wireless communications (or WiFi) networks. Such networks may implement IEEE recognized standards such as 802.11a, b, or g. Bluetooth™ may be used for moderate data transfer rates, but may be limited to short-range communications only in certain embodiments. Low-power protocols such as ZigBee™ may also be used, but may be limited to low data throughput speeds in certain embodiments.

The display and user interface module may display and interact with data and multimedia content in real time from a wireless network or other device, as well as content stored on external memory modules (e.g., hard drives) or cards (5) that may be factory- and/or reader-inserted into an appropriate docking connector (6). Internal RAM (7) may also be used to store operational and/or image content.

In one embodiment the display and user interface module utilizes a motion sensor (9) to determine if it is being transported or moved. This information may be used for power management to maximize battery life. If the display and user interface module is stationary and no movement is detected for a predetermined period of time and no data exchange is occurring, in one embodiment all communications (3, 4) will cease until motion is detected again or a reader-control function switch (2) is pressed. In the same manner, the display (1) backlight may extinguish under such conditions, also reducing power consumption until motion is detected or a reader-control function switch (2) is pressed.

The display and user interface module's rechargeable cell(s) (17) may be recharged by a conventional charger plug or via inductive coupling between an emitting coil and a receiving coil (12) forming a primary and secondary of a transformer, except without the physical packaging restraints of a conventional iron core transformer. The charging current is rectified and then regulated (13) and is used to provide charging current to the rechargeable cell(s) (17), which can be of any suitable chemistry, such as Nickel Cadmium, Nickel Metal Hydride, Lithium Ion, or the like. A two-color (e.g., red and green) charging status LED (16) may indicate if the display and user interface module is charging and when charging is complete.

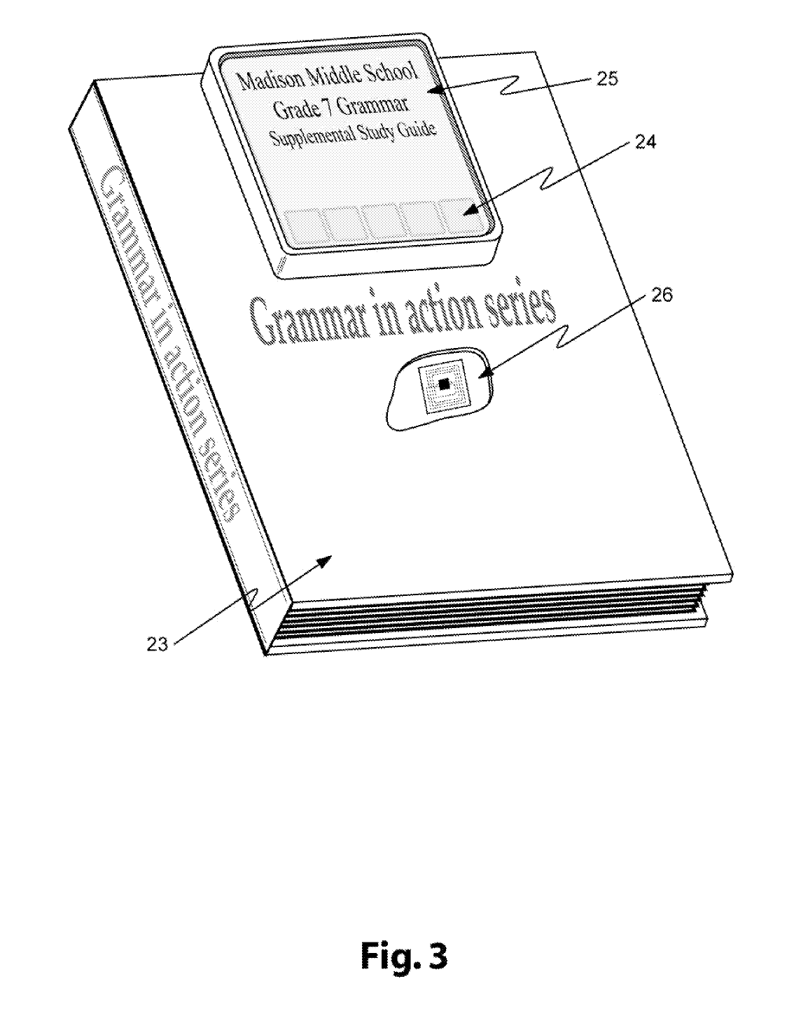

In certain embodiments, the display and user interface module may be capable of automatically associating itself with its host book by use of use of RFID (“Radio Frequency Identification”). This may be accomplished, for example, by reader control and upon activation enabling a tag interrogation carrier (18, as shown in FIG. 1) that powers the tag (26, as shown in FIG. 3) and then receives and logs the book's RFID data. If the tag is a writeable type, the display and user interface module may be capable of writing to the tag, indicating that the association sequence was initiated, which information may be used as an acknowledgement of usage. In certain embodiments, the display and user interface module may also comprise a camera (which may be integrated into the display and user interface module or embedded into a portion of the book, such as its front or rear cover) for capturing images and transmitting them to the display and user interface module (and/or to the storage device associated with it) for subsequent display. Depending on the requirements of each particular implementation, such a camera may also transmit image information remotely via any suitable wired or wireless communication medium.

FIG. 2 depicts an embedded version (20) of a display and user interface module in a book's front cover according to certain embodiments of the present invention, with the display oriented for viewing while the book (19) is closed. The display (20), or another display, may also be embedded into the book's rear cover or into a rigidized page-like insert. It is understood that embodiments of the present invention may be oriented in the reverse of the aforementioned orientation, wherein the display screen may face the inside of the book and be viewable with the book open. As mentioned earlier, the content electronically displayed on the display screen (22) may include data for tables and routines, as well as supportive graphics, pictures, and/or video content.

Still referring to the embodiment depicted in FIG. 2, the display screen (22) shows the title of the multimedia presentation in its operating state. If the display and user interface module can be turned off by the reader, or if no motion is detected for a predetermined period of time, the display may be extinguished and no image is be displayed. The control buttons (21) are shown for illustration purposes only and may vary (or may be omitted) according to final design for each application and/or implementation.

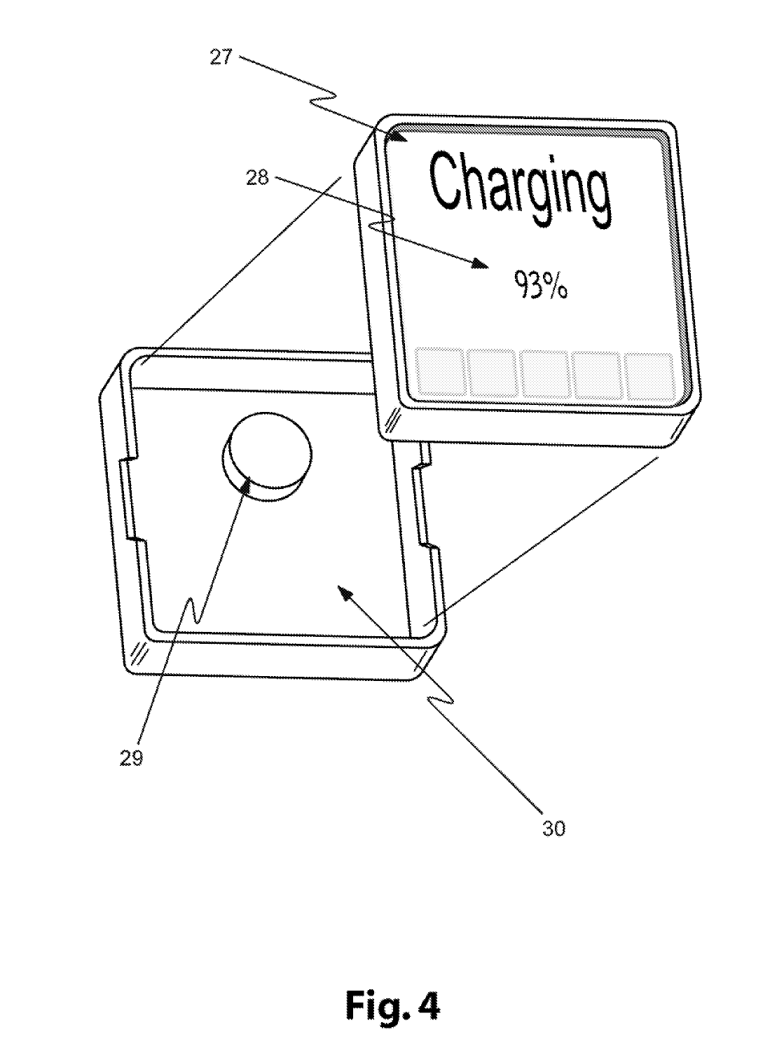

FIG. 3 shows an embodiment that comprises a clip-on version of a display and user interface module that can be attached to a book cover by any suitable fastener, for example, one or more spring-loaded clips. Alternatively, depending on the needs of each particular implementation, a display and user interface module according to aspects of the present invention may take the form of a sleeve or clip that may be attached (or that may surround) any conventional book. In the example depicted in FIG. 3, a text book (23) is shown. As shown in the embodiment depicted in FIG. 3, the display and user interface module is in the form of a self-contained, integrated assembly. The unit is shown with its display turned on. The lower section of the display includes an array of soft keys (24) whose functions may be software-created or generated and assigned functions through the use of a touch screen overlay. The clip-on version of the display and user interface module may be charged in its corresponding charging module as shown in FIG. 4 (30), which provides an ideal alignment of the charging coils. FIG. 4 illustrates an exemplary display and user interface (in a clip-on form factor) (27), and a portion of its corresponding charging device (30), with an exemplary charging status indicator (28) and a clip-on fastener (29).

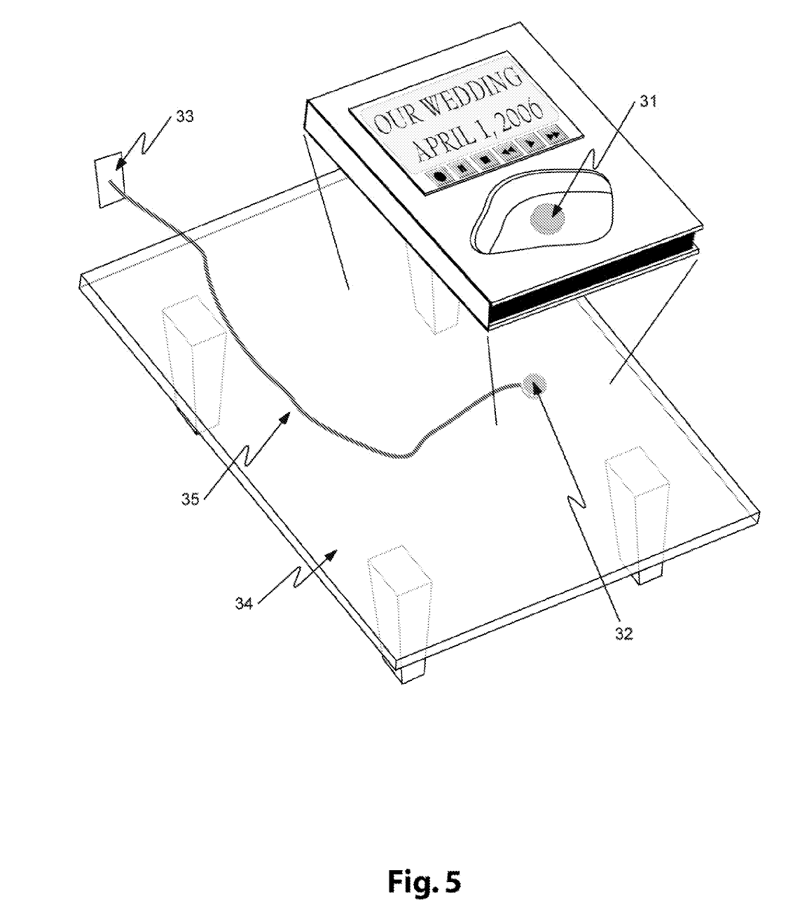

FIG. 5 illustrates an exemplary integrated book according to aspects of the invention, display and user interface (in an embedded form factor) being positioned to accept inductively coupled charge current (via wall socket 33 and connecting cable 35) from its corresponding, under-table displaced charging coil (32). The embedded version according to certain embodiments of the present invention (as shown in FIG. 5) may utilize an embedded charging coil (31) in its back cover that should align with the charging coil (32) that may be affixed to the under side of a coffee table (34) or other planar surface where such items might be displayed, for example.

The efficiency of using a non-integral transformer is significantly affected by the spacing and alignment of both the emitting and receiving coils. To optimize the locating of the host book upon the surface it is to reside upon as to be in alignment with the charging coil located below it, an LED (e.g., element 16 depicted in FIG. 1) may be used to indicate that the charging current is being received in an amount indicative of ideal alignment.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A book, comprising:
a binding that binds a front cover and a rear cover;
at least one page bound to said binding and disposed between said front and rear covers;
a controller for controlling display of one or more electronically generated images on a display device from image data stored in a storage device operably associated with the book, wherein at least a portion of said display device screen is visible through an opening in said front cover; and
a power supply for powering the controller and the display device.

2. A book according to claim 1, wherein the display device is attached to said front cover.

3. A book according to claim 1, wherein the display is attached to said rear cover.

4. A book according to claim 1, wherein said storage device is housed in the book.

5. A book according to claim 1, wherein said storage device is housed outside of the book, wherein image data stored in said storage device is transmitted to said controller, wherein said book further comprises circuitry for receiving and processing said transmitted data.

6. A book according to claim 1, wherein said electronically generated images for display are selected from the group consisting of still images, moving images, and a combination of still and moving images.

7. A book according to claim 1, further comprising speakers for outputting sound data stored in a storage device operably associated with the book.

8. A book according to claim 2, wherein one or more electronically generated images are displayed on the display screen when an actuation sensor disposed in the book and operably associated with the controller senses an actuation event.

9. A book according to claim 8, wherein said actuation event is selected from the group consisting of moving the book, touching the book, and detecting sound intensity above an actuation threshold.

10. A book according to claim 3, wherein one or more electronically generated images are displayed on said display screen upon opening of said front cover.

11. A book according to claim 10, wherein at least one of said pages has an opening in at least part of its surface area that exposes at least a portion of said display screen.

12. A book, comprising:
a binding that binds a front cover and a rear cover;
at least one page bound to the binding and disposed between the front and rear covers;
a controller for controlling display of one or more electronically generated images on a display device from image data received by said controller;
a display associated with said display device, having a display screen for displaying electronically generated images, wherein said display screen is visible through an opening in the front cover; and
a power supply for powering said controller and said display.

13. A book according to claim 12, further comprising a receiver configured to receive image data transmitted from a remote transmitter.

14. A book according to claim 1 or 12, wherein at least the display screen is covered with a concealing coating.

15. A book according to claim 1 or 12, wherein said electronically generated images for display are topically associated with the content displayed in said pages.

16. A book according to claim 1 or 12, wherein said book further comprises a receiving terminal for interfacing with a storage device containing one or more electronically encoded images and transmitting one or more of said images to said display device.

17. A book according to claim 1 or 12, wherein said controller initiates execution of an image-containing presentation on said display device upon detecting the opening of said book.

18. A book according to claim 1 or 12, wherein said controller initiates execution of an image-containing presentation on said display device upon detecting the closing of said book.

19. A book according to claim 1 or 12, wherein said power supply comprises one or more batteries embedded into a portion of said book.

20. A book according to claim 19, wherein said portion of said book into which said one or more batteries are embedded comprises a cover of said book.
